(19) United States
(12) Patent Application Publication
(10) Pub. No.: US 2026/0100434 A1
(43) Pub. Date: Apr. 9, 2026

(54) METHOD OF SOLVENT AND ELECTROLYTE EXTRACTION AND RECOVERY OF ELECTRODE POWDER IN LITHIUM-ION RECYCLING PROCESS

(71) Applicant: REGAIN SP. Z O.O., Wejherowo (PL)

(72) Inventors: Jan HUPKA, Gdansk (PL); Lukasz HUPKA, Reda (PL)

(21) Appl. No.: 19/120,753

(22) PCT Filed: Dec. 13, 2022
(86) PCT No.: PCT/PL2022/000070

§ 371 Date: Apr. 11, 2025

(30) Foreign Application Priority Data
Oct. 13, 2022 (PL) P.442518

(51) Int. Cl. H01M 10/54; B09B 3/80; B09B 101/16; H01M 10/0525

(52) U.S. Cl. CPC H01M 10/54; B09B 3/80; H01M 10/0525; B09B 2101/16

(57) ABSTRACT

A method of solvent and electrolyte extraction and recovery of electrode powder from lithium-ion cells, from a batch mixture containing solvents, the electrolyte and anode and cathode powders, in which the electrolyte is separated from the anode and cathode powder with a solvent mixture, while the solvent mixture is separated from the electrolyte through vacuum evaporation. The subsequent portions of the anode and cathode powder are separated from the subsequent batch portions fed to a reactor, obtaining the subsequent portions of the solvent mixture with the electrolyte. The solvents are separated from the electrolyte salts and added to the previously recovered solvents from the previous portions of the mixture of solvents and of the electrolyte. The obtained solvent mixture is returned to the reactor and subjected to extraction, recovering the subsequent quantities of the solvent mixture with the electrolyte, separated from the cathode and anode powder.

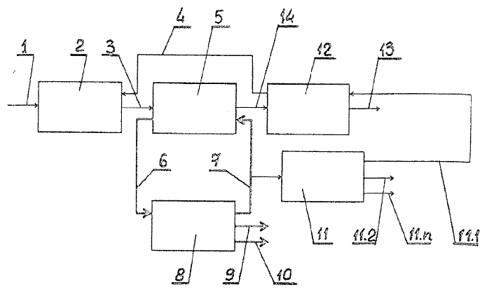

The subject of the invention is a method of solvent and electrolyte extraction and recovery of electrode powder in lithium-ion cell recycling process. The solution is used with used batteries of such a type.

The electrolyte in lithium-ion batteries is an intermediate in the ion exchange process and contains lithium salts dissolved in an organic liquid or a mixture of organic solvents. When selecting a combination of salts and solvents, the electrolyte should be characterised by high voltage stability, small co-interactions on the anode and reduction stability on the negative electrode. Safety of use and recycling are related to the chemical composition of the electrolyte and salts it contains because of solvent volatility, toxicity and low ignition point. The electric conductivity of the electrolyte has decisive influence on the rate of the battery charging and discharging cycle.

A range of solutions for the execution of the disposal process for recovery of materials for re-use in the same technological process of cell production or in other technological processes are known. The initial stage includes mechanical fractionation of batteries with separation into the basic components of cells. The first stage of fractionation usually is cell crushing in mills. Cooled cells are fed to the crushing device, wherein liquid nitrogen or carbon dioxide as dry ice are usually used in the cooling process. Adequate battery cooling before crushing causes the electrode material of the cells to solidify.

Because of the structure and chemical composition of cells with high energy density, they must be subjected to initial processing before the recovery of valuable raw materials for re-processing. The initial processing usually involves battery discharging, sorting, segregation, disassembly and separation from the package and preceded by fractionation of cell components, such as anode, cathode, separating element, electrolyte or binder. The basic unit operations include: battery separation through cutting and crushing and sieving of the crushed material. Because of the presence of toxic components, a range of hazards related to the execution of such processes in batteries with high energy density exists. These hazards are the consequence of the toxicity of battery components, the violent nature of some possible chemical and electrochemical reactions, flammability and thus of the susceptibility of some components to self-ignition.

A range of known solutions for the recycling process of used lithium-ion batteries is known in the art, aimed at metal recovery from such batteries.

According to the solution known from the publication of the international patent application WO 2011/035915, the recycling process is carried out in order to recover metals from lithium-ion batteries. This applies, in particular, to cobalt recovery from lithium-ion batteries also containing aluminium and copper. The recycling process according to this known solution includes a melting furnace equipped with oxygen nozzles, to which the metallurgic batch containing at least 15% of added calcium oxide is fed. The lithium-ion batteries are fed to the furnace together with oxygen. At least some cobalt is reduced and collected in the metallic phase. The slag is subsequently separated from the metallic phase.

In another solution, known from the publication of the international patent application no. WO 2011/035916, a recycling process aimed at metal recovery from batteries of electric hybrid vehicles or electric vehicles is presented.

According to this known solution, the process involves a furnace equipped with oxygen feeding measures, where calcium oxide CaO is added to the batch. The share of batteries, expressed as the weight % of the batch, is at least 40%. The batch is fed to the furnace with added oxygen. At least some nickel and/or cobalt is reduced and collected in the metallic phase. The slag is subsequently separated from the metallic phase. Said furnace is equipped with frozen slag collecting measures.

In another solution known from the publication of the international patent application WO 2015/096945, a method of metal and heat recovery from used lithium-ion batteries containing relatively small quantities of cobalt is disclosed. It was found, in particular, that such lithium-ion batteries may be processed in a copper melting furnace by feeding a useful batch and slag-forming agents to the melting furnace, followed by addition of heating and reducing agents. At least some of the heating and/or reducing agents are replaced with lithium-ion batteries containing one or more compounds of iron, aluminium and carbon. The use of used batteries as a raw material at a copper foundry causes the production rate of Cu blisters to increase, while the consumption of energy from fossil fuels decreases.

In another solution known from the patent document JP 2000226619, metal oxides containing alkaline metal generated during the secondary battery production process melts thanks to the addition of a reducing agent and a slagging agent in order to recover reduced and deposited, precious metals. Alternatively, ferrous material and metal oxides containing alkaline metals, the reducing agent and the slagging agent are loaded into the furnace and melted in order to recover the reduced and deposited metals as an iron alloy.

The solutions described above are focussed on melting metals present in lithium-ion batteries in furnaces, at high temperatures, and are thus related to solvent and electrolyte loss.

In a solution known from the disclosure of the Polish patent application P.440038, a method of fractioning batteries with high energy density is presented. The batteries are segregated according to their physico-chemical composition and then transferred to the battery container, where the batteries are cooled using gaseous CO₂ inside the hot chamber of the container, while cooling using dry ice is performed in the cold chamber of the containers and once the batteries reach temperatures below −34° C., they are crushed and subjected to pneumatic separation of the polymer fraction and magnetic separation of battery housing fragments. The crushed material was sieved in the vibrating sieve chamber and electrode powder is recovered for further processing. According to this known solution, the batteries are cooled in a CO₂ atmosphere and the initially cooled batteries are transferred to the cold chamber of the container, to which dry ice granules are simultaneously fed via a chute. During the first separation stage, the batteries are cut and next, the sliced material, mixed with dry ice, is ground in an impact mill during the second separation stage. Pneumatic separation of plastic particles is carried out in the impact mill and a mixture of electrode material particles is obtained as the crushed material. The material obtained during crushing inside the impact mill with pneumatic separator of plastics is fed to the vibrating sieve chamber, where the material sieved on the top sieve, >5 mm, preferably at −35° C., is subjected to pneumatic separation, separating polymer material fragments. Next, the residue is fed to the magnetic separator I, where metal magnetic parts are separated, wherein the sieved material, >1 mm, from the bottom sieve is also fed to the magnetic separator I, where magnetic particles are separated again from the residue comprising electrode material, containing cathode and anode powder and electrolyte, solidified at this temperature. In this known solution, batteries and dry ice granules with diameter of 3 mm to 16 mm are preferably fed simultaneously to the cutting and separation chamber, wherein the cutting unit cuts the mixture of batteries and added dry ice granules into slices, 7 to 12 mm thick. According to this known solution, fractioning of used batteries comprises the first stage of the recycling process and enables separation of the sieved material comprising ca. 60-70% of the cell weight and containing the cathode-anode powder, electrolyte and solvent. This material can be contaminated with iron particles, although it was previously subjected to magnetic separation according to this known solution, as the prior magnetic separation is intended to remove known ferromagnetic fragments of the housing, larger than 1 mm.

This sieved material, comprising ca. 60-70% of the weight of the cells, from the fractioning process on the sieves, is subjected to further processing according to the solution comprising the subject of this invention. The aforementioned, sieved material includes the following materials:
solvents,
electrolyte in the form of salts of said metals,
anode powder and cathode powder,
   The composition of individual materials is presented below:

### Solvents

Lithium-ion batteries based on a liquid electrolyte contain organic solvents, such as EC ethylene carbonate, PC propylene carbonate, DMC dimethyl carbonate, EMC ethyl-methyl carbonate and/or DEC diethyl carbonate. The EC and DMC solvents impart improved durability to the lithium-ion cells, forming a stable inter-phase layer on the graphite anode. They are also present in a mixture with other organic solvents in order to decrease the melting point from 35° C. and 3°C to −50° C. and −74° C., respectively.

### Electrolytes

The key properties taken into account during selection of the salt as an electrolyte component in a lithium battery include: performance at low temperatures, safety, conductivity, resistance to temperature increase, stability related to oxidation and reduction, solubility, cycle efficiency, resistance to moisture, toxicity levels and susceptibility to violent decomposition. LiPF₆ is the salt most frequently used in the electrolyte. Other salts used in lithium-ion batteries includ LiFSI, LiCF₃SO₃, LiBF₄, LiClO₄, LiAsF₆, as well as more complex, organic lithium salts, such as LiTFSI, LiC₂F₆NO₄S₂, CF₃LiO₃S or LiC(SO₂CF₃)₃.

### Cathode Powder and Anode Powder

The cathode material (LiCoO₂, LiFePO₄, LiNiMnCoO₂, LiMn₂O₄, LiNi_{0.8}MnCo_{0.15}Al_{0.05}O₂) is attached to aluminium foil using a conductive powder in the form of acetylene soot and poly(vinylidene fluoride) PVDF as a binder. This system is the positive electrode. The negative electrode is made of carbon powder in the form of natural graphite HC fixed on copper foil using PVDF. The anode and the cathode are separated by a polypropylene membrane, permeable to electrolyte ions. The electrolyte is a solution of lithium salts in organic solvents.

The possibility of reaching a hazardous concentration of volatile compounds during the recycling of used lithium-ion batteries at ca. 0° C. or at ambient temperature (21° C.), and especially at elevated temperature, is a consequence of properties of the used solvents and salts, unless this fact is taken into account in the technological process. In the known lithium-ion battery recycling processes, the solvents are usually removed using heat, which causes decomposition, evolution and emission of gases. This poses problems related to environmental pollution and high energy consumption.

According to the invention, the process used to separate the solvents and the electrolyte, as well as recovery of the electrode powder from lithium-ion cells, from the batch mixture containing solvents, electrolyte and anode and cathode powders, obtained during low temperature separation and fractioning of used lithium-ion batteries on sieves, characterised in that solvent with electrolyte containing non-magnetic metal compounds are separated from the mixture batch in the reactor.

The method according to the invention is characterised in that the electrolyte is separated from the anode and cathode powder via extraction using a solvent mixture, whether the solvent mixture is separated from the electrolyte via vacuum evaporation and subsequently, individual portions of the anode and cathode powder are separated from individual batch portions of the mixture fed to the reactor, obtaining individual portions of the solvents and electrolyte mixture. Next, solvents are removed from the electrolyte salts and added to the previously recovered solvents from the previous portions of the mixture of solvents and of the electrolyte. The thus obtained mixture of solvents is returned to the reactor and, via extraction, individual portions of the mixture of solvents with the electrolyte are obtained, separated from the cathode and anode powder, followed by collection of the recovered quantities of the solvent mixture, the recovered non-ferrous metal salts separated from the solvent mixture and the recovered cathode and anode powder.

The solvent and electrolyte extraction from individual mixture batches fed to the reaction is preferably performed in the countercurrent.

In a preferable variant of the solution according to the invention, the recovery of the solvent mixture from the batch mixture is carried out after the battery powder is mixed with at least one battery solvent.

The solvent is preferably ethylene carbonate EC and/or propylene carbonate PC and/or dimethyl carbonate DMC and/or ethyl-methyl carbonate EMC and/or diethyl carbonate DEC.

The solvent mixture may be recovered in vacuum, in a rotary evaporator.

The electrolyte solution is preferably concentrated in the solvent, as a concentrate.

In another variant of the embodiment of the invention, extraction is carried out in the first phase of the process using dimethyl carbonate DMC.

In the last phase, concluding the extraction process, the powder is preferably washed with the solvent, dimethyl carbonate DMC.

In a solution according to the invention, the use of the listed own solvents present in batteries subjected to the recycling process according to the invention is proposed, in order to extract the electrolytes from individual batches of such batteries fed to the reactor. In the solution according to the invention, the solvents present in individual cells are collected by fractioning at low temperatures using circulation of CO₂ obtained from dry ice applied to the cell mixture during the initial stages of separation of the lithium-ion cells. The extraction is thus carried out in the reactor, using the solvent recovered from the cell according to the method proposed in the disclosure.

In the case of periodic extraction, the reactor is filled with a suspension of electrode powder in a solvent, in the weight ratio of the electrode material to the liquid phase between 1:6 and 1:3, preferably 1:4. The electrolyte and the solvent are recovered during evaporation of the organic solvent present in the electrolyte.

The electrolyte contains organic solvents (such as ethylene carbonate) [EC], propylene carbonate [PC] and dimethyl carbonate [DMC], as well as lithium salts (LiPF6). In the known lithium-ion battery recycling processes, the solvents are removed using heat, which causes decomposition, evolution and emission of gases. The environment may become polluted during this energy-consuming process. Thanks to the electrolyte recycling according to the invention, using extraction with own solvent present in the cells, energy consumption was decreased, as well as uncontrolled emissions from the selected, individual operations were eliminated. Electrolyte recovery through extraction with own organic solvent enables an economically preferable increase of the process scale.

In the solution according to the invention, the solvent circulates through a closed circuit and is returned to the extraction process of individual batch portions of cells intended for recycling. After the extraction of individual batches in the reactor, the composition of the solvent gradually approaches the technological composition used in the processed battery type, which enables over 99.5% of weight of the electrolyte to be separated from the cathode powder and the anode powder according to the proposed method. The excess of the solvent and of the electrolyte containing lithium salts, present in it, is a product resulting from the presented process, meeting the requirements for substrates, suitable for use in production of new lithium-ion batteries. On the other hand, solvents were a waste material from the recycling process in solutions known from the art.

In the solution according to the invention, the solvent or the mixture of solvents is a substrate in the first stage, for recovery of individual portions of the electrolyte from individual reactor batches, while further, excessive quantities of the solvent from the electrolyte solution and of the recovered lithium salts may be used in production processes of new batteries. Electrolyte recovery through extraction of the recovered organic solvent thus decreases environmental pollution, eliminates emissions of volatile compounds and enables large-scale electrolyte recycling from individual reactor batches and of the solvent mixture, electrolyte and anode and cathode powder, obtained from battery fractioning.

The subject of the invention is presented in the following embodiment, illustrating the solvent and electrolyte extraction and recovery of electrode powder in the recycling process of lithium-ion cells. The method according to the invention is also presented in the attached FIGURE presenting the block diagram of the method according to the invention.

The method is related to the separation of electrolyte and solvent from the electrode material, in the form of a solution containing both these components, separation of this solution and recovery of the electrode powder containing anode material and cathode material from the used lithium-ion cells. The raw material is a batch mixture containing solvents, electrolytes, anode and cathode powder, obtained during low temperature separation and fractioning of the used lithium-ion batteries on sieves. The technology of the invention is used to separate a batch of said mixture, in the amount of 10 kg, in an extractor, where solvent and electrolyte containing compounds of non-magnetic materials are separated.

The electrolyte solution in this embodiment contains lithium hexafluorophosphate (LiPF₆) at a concentration of 1 mol/L and a solvent mixture in the form of ethylene carbonate (EC), dimethyl carbonate (DMC) and diethyl carbonate (DEC) in the volumetric ratio of 1:1:1, separated from the anode and cathode powder via solvent extraction.

The separation of the electrolyte and of the solvent is carried out in the existing solvent system present in lithium-ion cells. The presence of the indicated organic solvents dissolves the electrolyte and ensures efficient mass exchange, or ion exchange between the anode and the cathode. However, because of the viscosity of the electrolyte solution ranging from 1 to 15 cP, the viscosity of the electrolyte solution was decreased. 99.9% of the electrolyte is removed from the electrode powder.

In this embodiment, during the first stage of the separation process, extraction is carried out using solvent, which is the most volatile component of the electrolyte solution in the process. Thus, heavier fractions of the mixture are diluted and extraction is facilitated. In this embodiment, with the mixture of the aforementioned EC+DMC+DEC solvents, dimethyl carbonate DMC is used to initiate the extraction process as the most volatile of the three solvents present in the electrolyte, in a quantity three times bigger than that in the cell.

Next, following the first stage of extraction, an extraction using a mixture of the solvents present in the electrolyte is carried out, or in this embodiment, the aforementioned EC+DMC+DEC mixture in volumetric ratios 1:1:1, and in mass ratios of the electrode material to the liquid phase of 1:3. The extraction using a solvent mixture at technological concentration in batteries in other embodiments can involve a single or multiple stages, depending on the purity requirements for the cathode and anode material.

Next, the solvent mixture is separated from the electrolyte via vacuum evaporation in a vacuum evaporator, under a 30 mbar vacuum.

Next, from the subsequent batch portions in the amount of 10 kg of the mixture fed into the reactor, the anode and cathode powder is separated through extraction, 3-stage extraction in this embodiment, obtaining individual portions of the solvent mixture with the aforementioned quantitative composition of 1:1:1 and qualitative composition EC+DMC+DEC close to the process concentration of lithium-ion batteries, with the electrolyte containing lithium hexafluorophosphate (LiPF₆).

Next, subsequent portions of the solvent mixture, in this case in the amount of 1 litre per portion, are separated from the electrolyte salts and a solvent mixture with the aforementioned quantitative composition of 1:1:1 and the qualitative composition of EC+DMC+DEC is obtained and added to the previously obtained portions of the solvent mixture with the same composition.

The thus obtained solvent mixture is returned to the reactor and subjected to extraction, recovering individual quantities of the aforementioned solvent mixture with electrolyte, with the same composition, separated from the anode and cathode powder.

Next, the recovered quantities of the solvent mixture, non-ferrous metal salts after electrolyte evaporation and of the cathode and anode powder which can be used in production of new lithium-ion cells are collected.

In this embodiment, the solvent and electrolyte extraction from individual mixture batches fed to the reactor is performed in the counter-current, namely the substances are transferred in the direction opposite to the refined material and the solvents, between which lithium salts are exchanged (transferred) to the solvents, and in the last stage, namely in the final washing stage, heavier solvents are washed using a more volatile solvent.

During the next stage, the solvent mixture is recovered from the batch mixture after mixing the battery powder with one or more battery solvents.

In this embodiment, the solvent is ethylene carbonate EC and propylene carbonate PC and dimethyl carbonate DMC and ethyl-methyl carbonate EMC and diethyl carbonate DEC mixed together in equal proportions. One of the listed solvents or a mixture of selected solvents is used in other embodiments.

In this embodiment, the indicated solvent mixture is recovered under a 30 mbar vacuum, in a rotary evaporator.

In this embodiment, lithium salts in the form of a LiPF₆ solution are concentrated in the solvent, obtaining an electrolyte concentrate with the salt content of 4.2 mol/L. In other embodiments, the salt content varies from 3 to 6.5 mol/L.

The attached drawing shows an example block diagram for the technological process according to the invention. Batch 1 is defined as raw material containing the cathode and anode electrode materials, solid or semi-solid electrolyte in the form of a solvent mixture and lithium salts and containing solid carbon dioxide CO₂.

Initial extraction 2 is performed using a light, volatile solvent, e.g. the aforementioned DMC, in a reactor, with the mixer rotation rate of 100-500 rpm. The DMC solvent may be obtained from separation of the solvent mixture 7 after its separation from the electrolyte. Initial extraction 2 takes place at the beginning, in order to initiate the extraction process. The subsequent batches 1 of the material are fed to the reactor directly during the proper extraction 5.

The light solvent is a highly volatile solvent, or a solvent with low boiling point, in this embodiment this is the DMC solvent comprising a component of the solvent mixture 7 of the electrolyte in the cells and which is separated from the solvent mixture 7 present in the lithium-ion cell and which is returned to the final extraction stage defined in the diagram as final washing 12 and directed as an extract to the initial stage defined in the attached block diagram as initial extraction 2. The raffinate 1 designated as 3 in the attached block diagram is defined as batch 1 together with the aforementioned DMC solvent in the mass ratio of 1:1.

The proper extraction 5 is defined in the attached diagram as a single or multiple stage extraction in a solvent mixture obtained from recovery, or from said separation from the electrolyte solution. In this embodiment, this is the mixture of the aforementioned EC+DMC+DEC solvents, in a volumetric ratio 1:1:1, and the aforementioned EC+EMC solvent mixture in the volumetric ratio of 3:7, respectively, and the aforementioned EC+DMC+DEC solvent mixture in the volumetric ratio of 4:3:3, respectively. The solvent mixture recovered through evaporation in a rotary evaporator is returned to the reactor, where the proper extraction 5 takes place at 5° C. to 90° C., with the mixing rate between 80 rpm and 800 rpm. In this embodiment, the proper extraction 5 is carried out with the mixer rate of 400 rpm, at the ambient temperature of ˜21° C.

Raffinate 2 is designated in the attached block diagram as the 14 cathode and anode paste with a small amount of the inherent solvent mixture, in this embodiment EC+DMC+DEC, in the specified volumetric ratio of 4:3:3, respectively, free of lithium salts. The volumetric ratio of individual solvents in other embodiments of this and the previously mentioned solvent mixtures may be different.

The electrolyte solution 6 is designated in the attached process diagram as a solution containing a solvent mixture similar in terms of its process composition to the mixture present in the cells. The solvent evaporation 8 from the electrolyte solution 6 shown in the diagram is carried out in a rotary evaporator. The solvent mixture 7 is separated in said evaporator under the vacuum of ca. 30 mbar.

The electrolyte concentrate 9 indicated in the diagram is obtained after partial evaporation of the solvent mixture 7. According to the diagram in the attached FIGURE, the electrolyte in the form of lithium salts 10, LiPF₆ in this embodiment, is obtained after complete evaporation of solvents from the electrolyte solution.

The solvents in the form of the mixture 7 obtained in this embodiment through solvent separation in a rotary evaporator, are returned to the proper extraction and their excess is transferred to solvent 11 separation into individual solvents 11.1, 11.2, 11.n, into the aforementioned EC, DMC and DEC. In the attached process diagram FIGURE, the 11.1 solvent indicates the most volatile solvent, for example the aforementioned DMC characterised by its boiling point of 90° C. The 11.2 solvent indicates the next most volatile electrolyte solvent, for example, the aforementioned DEC solvent with its boiling point of 127° C. The next solvent designated in the process diagram FIGURE is the 11.n solvent, namely the next most volatile electrolyte solvent. In this embodiment, this is the aforementioned EC solvent with the boiling point of 243° C.).

In the attached process diagram, the final washing 12 indicates extraction, or washing the remaining traces of heavier solvents present in the cathode and anode material after the proper extraction 5. The lightest solvent which is a component of the electrolyte solvent in the process is used in the washing. In this embodiment, this is the aforementioned 11.1 solvent, namely DMC. High-quality, pure cathode and anode material is obtained after this operation. The LiPF₆ lithium salt was previously removed during the initial extraction 2 and the proper extraction 5. The use of the light solvent additionally purifies the material and facilitates drying thanks to the high volatility of this solvent. For example, the aforementioned DMC solvent washes out residues of the aforementioned DEC and EC solvents.

As shown in this embodiment in the process diagram, the final raffinate 3 designated as 13 is obtained after the final washing 12, a high purity cathode and anode powder, with the electrolyte, namely salts, and the solvent removed. On the other hand, the extract 4 from the final washing shown in the diagram includes in this embodiment the light solvent 11.1, e.g. the aforementioned DMC, together with a small quantity of the heavier solvents 11.2, 11.n, also mentioned above, for example as DEC and EC.

### List of Designations Used in the Drawing

1. Batch
2. Initial extraction
3. Raffinate 1
4. Extract
5. Proper extraction
6. Electrolyte solution
7. Solvent mixture
8. Solvent evaporation
9. Electrolyte concentrate
10. Electrolyte (lithium salt)
11. Solvent separation
11.1. Solvent 1
11.2. Solvent 2
11.n. Solvent n
12. Final washing
13. Raffinate 3
14. Raffinate 2

1. A method of solvent and electrolyte extraction and recovery of electrode powder from lithium-ion cells, from a batch mixture containing solvents, electrolyte and anode and cathode powders, obtained during low temperature separation and fractioning of used lithium-ion batteries on sieves, wherein the solvent with electrolyte containing non-magnetic metal compounds are separated from the mixture batch in the reactor, wherein
the electrolyte is separated from the anode and cathode powder through extraction using a solvent mixture, wherein
the solvent mixture is separated from the electrolyte through vacuum evaporation,
and next, the subsequent portions of the anode and cathode powder are separated from the subsequent batch portions fed to the reactor, obtaining the subsequent portions of the solvent mixture with the electrolyte,
wherein, solvents are removed from the electrolyte salts and added to the previously recovered solvents from the previous portions of the solvents mixture with the electrolyte,
and the thus obtained solvent mixture is returned to the reactor and subjected to extraction, recovering the subsequent quantities of the solvent mixture with the electrolyte, separated from the cathode and anode powder,
wherein the recovered quantities of the solvent mixture and the recovered salts of non-ferrous metals are collected after their separation from the solvent mixture, as well as the recovered cathode and anode powder.

2. The extraction method according to claim 1, wherein the solvent and electrolyte extraction from individual mixture batches fed to the reactor is performed in the countercurrent.

3. The extraction method according to claim 1, wherein the recovery of the solvent mixture from the batch mixture is carried out after the battery powder is mixed with at least one battery solvent.

4. The extraction method according to claim 3, wherein the solvent is ethylene carbonate EC and/or propylene carbonate PC and/or dimethyl carbonate DMC and/or ethyl-methyl carbonate EMC and/or diethyl carbonate DEC.

5. The extraction method according to claim 1, wherein the solvent mixture is recovered under vacuum, in a rotary evaporator.

6. The extraction method according to claim 1, wherein the electrolyte solution is concentrated in the solvent as a concentrate.

7. The extraction method according to claim 1, wherein the extraction is carried out in the first stage of the process using dimethyl carbonate DMC.

8. The extraction method according to claim 1, wherein in the last stage concluding the extraction process, the powder is preferably washed with the solvent in the form of dimethyl carbonate DMC.
